(19) United States
(12) Patent Application Publication
(10) Pub. No.: US 2014/0083365 A1
(43) Pub. Date: Mar. 27, 2014

(54) CAGE FOR GROWING MOLLUSKS, ASSEMBLY KIT, AND METHOD OF HARVESTING MOLLUSKS

(71) Applicant: John Matthew MCSHANE, Olney, MD (US)

(72) Inventor: John Matthew MCSHANE, Olney, MD (US)

(21) Appl. No.: 14/035,379

(22) Filed: Sep. 24, 2013

Related U.S. Application Data
(60) Provisional application No. 61/704,809, filed on Sep. 24, 2012.

(51) Int. Cl. A01K 61/00; A01K 80/00

(52) U.S. Cl. CPC A01K 61/002; A01K 80/00
USPC 119/234; 119/452

(57) ABSTRACT

A cage for use in farming mollusks comprises a meshed wall with end caps that are snapped into place on the wall during construction. The end caps include removable portions for gaining access to the interior of the cage. A vessel for farming mollusks is fitted to receive a cage for processing of the cage and the mollusks therein. A method of using the vessel and cage includes the on-board treatment of the cages and mollusks.

### CROSS REFERENCE TO RELATED APPLICATION

This application claims priority of U.S. Provisional Application 61/704,809, which was filed on Sep. 24, 2012.

### TECHNICAL FIELD

This invention relates to the art of oyster farming and, in particular, to an inventive cage for growing oysters, a kit for constructing the cage, and a method of use.

### BACKGROUND ART

Known cages for farming oysters are typically made of a square metal mesh material that retains the oysters but allows water and nutrients to flow freely through the cage. These cages may be rectangular or cylindrical and include doors or removable end caps that can be opened to allow young oysters to be placed inside or grown oysters to be removed.

In a prior art method of oyster farming, an operator typically pulls a large number of cages from the body of water and loads them on a barge for transport to a dock for treatment of the cages. The cages are then reloaded onto the barge for transport back to the farming location in the body of water. This is very time-consuming and requires a large investment in equipment.

As oyster farming on a relatively small scale has become more popular, however, the need for inexpensive oyster cages and simplified farming methods has increased. As well, improvements are required to make the oyster cages easier to make and use and thereby to decrease the time required to load, unload, or clean them.

It is object of this invention to provide an oyster cage that is easy to use and a kit that is easily shipped and allows easy assembly of cages.

Another object of this invention is to provide an improved method for managing oyster cages having growing oysters therein.

### SUMMARY OF THE INVENTION

In accordance with the invention, an oyster cage comprises a permeable cylindrical portion with easily attached end caps closing the ends of the cylinder. As well, at least one of the end caps is easily opened to allow access to the interior of the cage.

In a preferred embodiment, the cylindrical portion of the cage is made of a flexible mesh material, such as a plastic mesh, that can be shipped flat but easily formed into a cylindrical configuration by the user. After the mesh is formed into a cylinder, end caps may be easily snapped onto the circular edges of the cylindrical portion to complete the construction. A preferred end cap comprises a plastic rim that snaps onto the edges of the mesh. The rim has a threaded internal surface that receives a screw top that is easily installed to close the cage or be removed to allow access.

In a method of using oyster cages in oyster farming, including those disclosed herein as well as others, several oyster cages having oyster seeds or young oysters therein are removably attached to a line, such as a rope. The cages and the rope are then placed in a body of water for growing the oysters, with one or more buoys or other locating devices optionally indicating the location of the cages. Management of the oysters in the cages is facilitated through the use of a novel barge that is specifically configured to allow an operator to retrieve each cage from the body of water, place it on a tumbler or sorter on the vessel, and then return the cage to the body of water. This method provides significant improvements in the efficiency of oyster farming because, among other reasons, the manager can easily retrieve a cage from the body of water, clean the cage, remove oysters from the cage or add new oysters to the cage, and then return it to the water, in a minimum number of steps and without requiring return trips to a dock.

### BRIEF DESCRIPTION OF THE DRAWINGS

FIG. 1 is a perspective view of a preferred embodiment of a cage according to the invention.

FIG. 2 is an exploded view of the cage of FIG. 1.

FIG. 3 is a perspective of a second embodiment of a cage according to the invention.

FIG. 4 is a plan view of a mesh wall as part of a kit for constructing cages in accordance with the invention.

FIG. 5 is a schematic of a barge useful for practicing the method of the invention at a first stage of the method.

FIG. 6 is a schematic of the barge of FIG. 5 at a subsequent stage of the method.

### DETAILED DESCRIPTION OF THE PREFERRED EMBODIMENTS

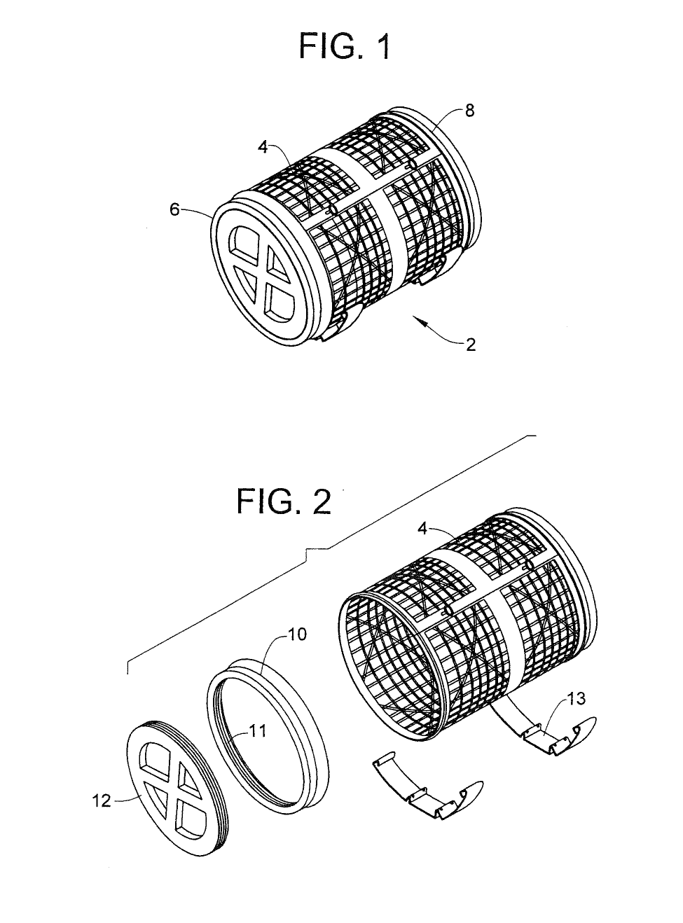

With reference to FIGS. 1 and 2, an oyster cage 2 in accordance with the invention comprises a mesh wall 4 in the shape of a cylinder and two end caps 6, 8 secured to opposed ends of the cylinder. At least one, and preferably both, of the end caps 6, 8 comprises a rim 10 that is secured to an edge of the mesh wall and includes a threaded interior surface 11 that receives a screw-on cap 12. A preferred end cap is a lid configured to be a lid for a plastic bucket and sold under the trademark Gamma Seal. The Gamma Seal lid has been found convenient for use as end caps for the cages of the invention because they are easily snapped onto the mesh wall and then easily opened by unscrewing the lid and reclosed by replacing the lid. Other end caps can be used, however, to accomplish the objectives of the invention.

For example it is within the scope of the invention to use a known snap-on type of bucket lid as end caps to close the ends of the cage instead of a Gamma Seal lid. This closure would be snapped onto the ends of the mesh wall in the known manner of closing a plastic bucket, and removal of the end cap to add or remove oysters would be accomplished by removing the end cap physically by detaching it from the wall. Alternatively, an end cap can be pivotally attached to the ends of the cages by providing a frame (similar to rim 10) that attaches to the mesh wall (as by snapping on in the manner of the Gamma Seal lid) with a hinge for pivoting a portion of the end cap between open and closed positions. Additional options for end caps are lids manufactured by BayTec and Lesco.

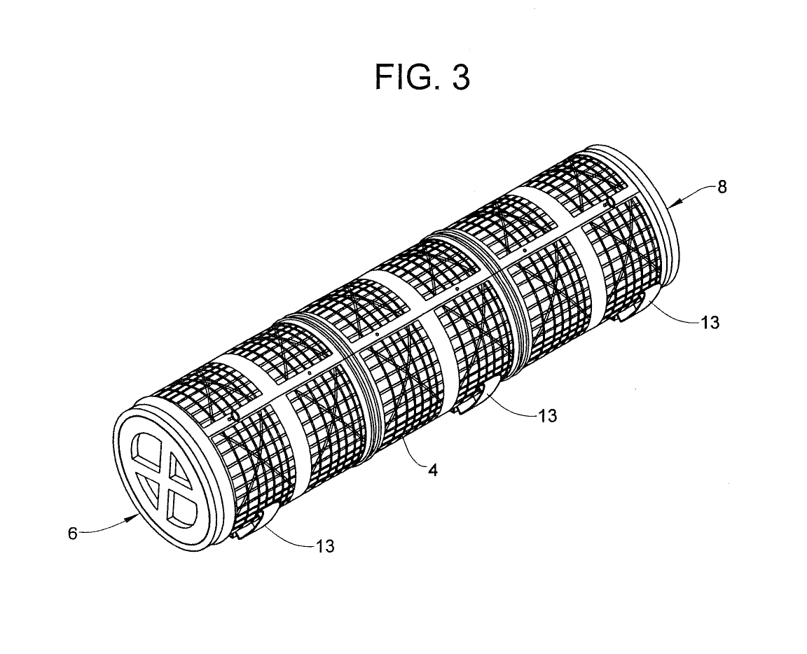

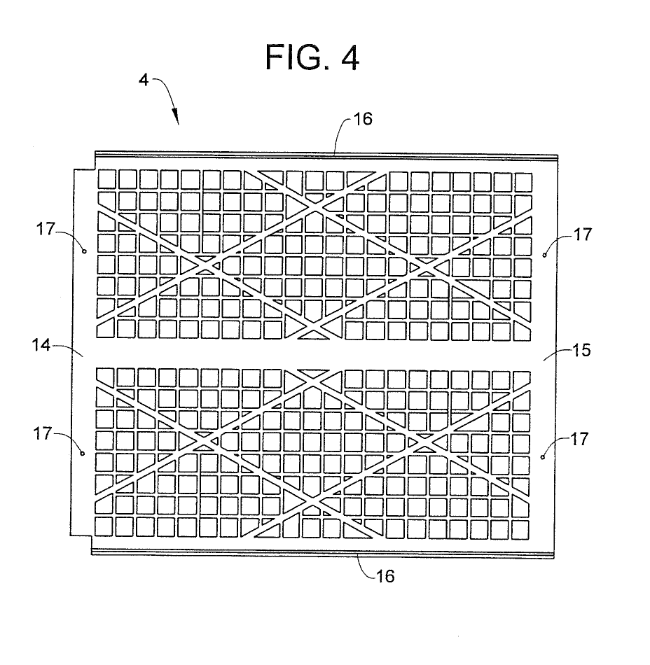

FIG. 3 shows an embodiment of the cage of the invention that has been formed of several smaller mesh walls 4 of the type shown in FIG. 4. Comparison of FIGS. 2 and 3 illustrate how the mesh walls can be combined to construct cages of different length and diameter. FIGS. 2 and 3 also show feet 13 that are curved to fit the shape of the cage and to extend around the bottom of the cage by a distance sufficient to prevent the cage from falling over and to space the cage from the floor even if the cage rotates when placed in the body of water. The angular extent of the feet is preferably at least 60° and can be in the range of 30° to 90°. The feet can be attached to the mesh wall in any of several ways, the preferred method being the provision of attachment tabs 13′ that have slots for engaging individual parts of the mesh wall. Of course, clamps, hooks or other attachment devices could be used. The semicircular configuration of the feet prevents the cages from being flipped over due to the action of waves, and the rolling action caused by the shape of the feet may itself condition the oysters.

FIG. 4 illustrates the mesh wall 4 having a preferred mesh pattern. The mesh wall is preferably made of HDPE or machine grade plastic and has an opening size chosen to retain the oysters (or other mollusks) of the initial size being grown. The cross bracing in the pattern provides added strength to the wall. Two of the opposed edges 14, 15 of the mesh wall 4 are provided with means 17 to connect them together or to another mesh wall depending on the desired diameter of the finished cage. In the embodiment illustrated, an attachment strip 14 extends from the wall and can be attached to the opposite end 15 of the wall when the wall is formed into a cylinder. The attachment strip can be secured to the opposite end 15 by screws, rivets, adhesives, or other known techniques. As well, the attachment strip 14 can be in the form of connection loops (not shown) arranged so that when the mesh wall 4 is formed into a cylinder the loops on one side are adjacent mating loops on the other end 15 whereby each of the loops can be attached to the adjacent end of the mesh wall or to another loop to retain the mesh wall in the desired shape.

Each of the other set of opposed edges 16 is formed in the shape of a ridge (for example, protruding outward and downward and triangular in cross section) to receive a respective one of the rims of the end caps 6 and 8. Preferably the ridge is configured to receive a correspondingly shaped recess in the rim 10. If a separate rim 10 is not used, the ridge can cooperate with the edge of a one-piece lid. Thus, an end cap with a correspondingly shaped structure can be attached easily to the mesh wall 4 by simply aligning the ridge on the wall with the recess on the end cap and snapping the two together. Other configurations are within the scope of the invention. For example, the ridge need not be continuous and can comprise a series of segments provided the number of segments will have adequate strength to retain the end cap during use. Moreover, a wide variety of structures will provide an easy connection between the cap and the wall of the cage.

A kit in accordance with the invention comprises one or more of the mesh walls 4 and one or more end caps 6 or 8. An advantage of this kit is that the cage can be easily shipped with the mesh walls flat, and providing a plurality of the walls allows cages of different sizes to be constructed. Moreover, multiple kits can be shipped in a single package.

In one embodiment the mesh wall 4 can be 36 inches high to form a 36-inch long cage about 12 inches in diameter. The cage may be longer or larger in diameter without departing from the concept of the invention. To form a cage, the user need only roll the mesh wall 4 into a cylindrical shape, secure the edges 14 and 15 to each other or to an adjacent mesh, and snap the ends caps 6, 8, on the opposed ends 16 of the mesh.

It will be appreciated that the cage need not be strictly cylindrical but can be elliptical, rectangular, and the like. The cage may optionally be provided with feet to reduce the likelihood that the cage will sink in mud at the bottom of the body of water in which it is placed and impede free flow of water to the oysters.

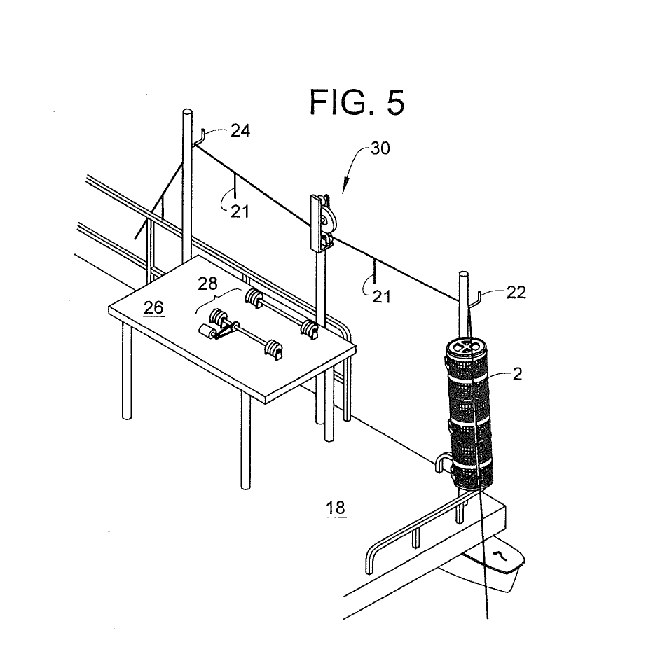

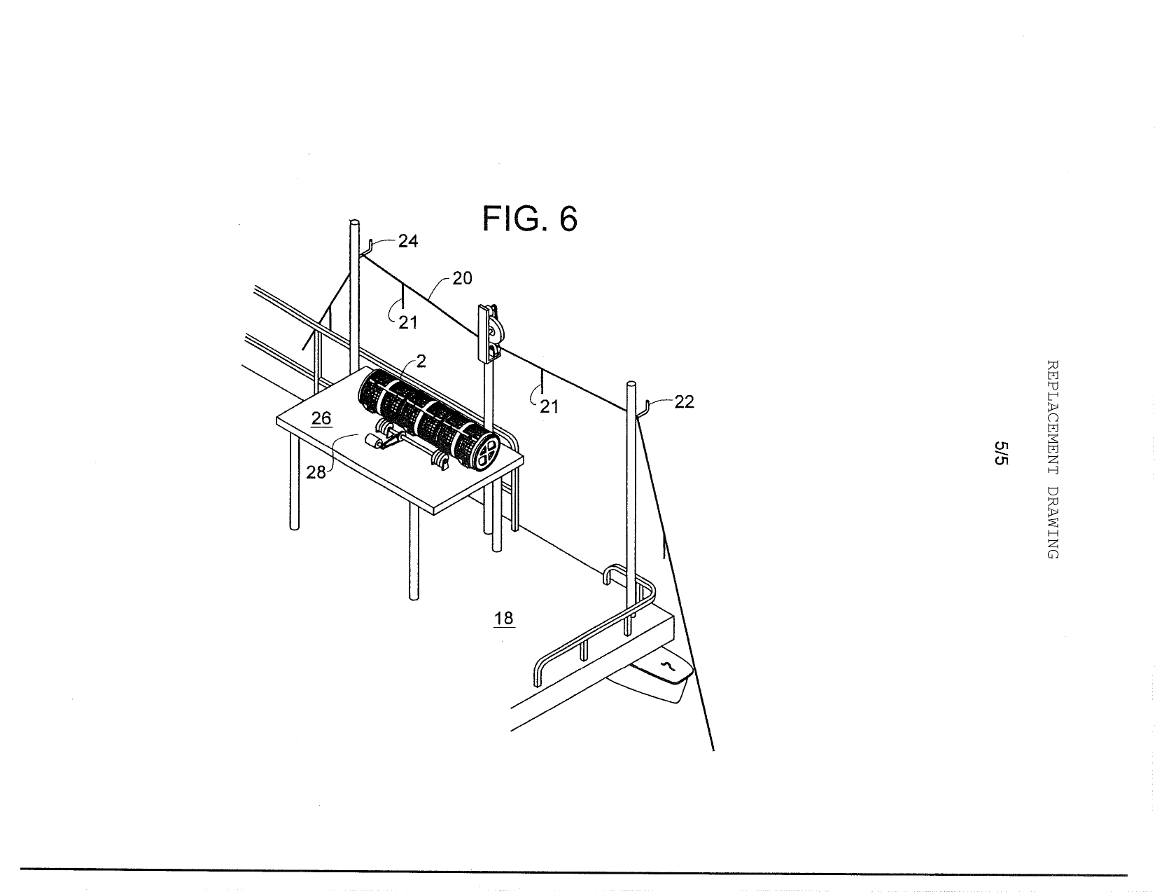

A preferred method for using the novel cages for growing oysters will be explained in connection with FIGS. 5 and 6, which shows a vessel 18 (e.g., a barge) specially configured to use the cages in oyster farming. In a preferred embodiment, a desired number of cages 2 are attached to a rope 20, as by known fishing line clips 21 (not shown) or other clips that can removably attach the rope to a cage. A clip 21 is provided at least at each end of the cage, but more clips can be used if desired. At least one of the clips for each cage is attached to the rope 20 such that its position on the rope is fixed whereby the position of a cage on the rope is known and the rope can pull the cage out of the water. This can be accomplished by threading the clip through the rope or by tying a knot in the rope and threading the clip through the knot, or by any of several additional techniques as will be appreciated by those of skill in the art.

Initially, the cages are provided with young oysters or oyster seeds, attached to the rope at predetermined intervals, and placed in the body of water. The cages are then regularly pulled from the body of water for cleaning, sorting, harvesting, etc., and then returned to the body of water. This is accomplished from the vessel alone and obviates the necessity of return trips to a dock to treat the cages.

The vessel 18 includes rope guides 22 and 24 that extend to the side of the vessel and support the rope 20 as each cage 2 is sequentially removed from the rope and then reattached after treating the cage and the oysters. Configuring the guides to extend to the side of the vessel facilitates manipulation of the rope with respect to the boat. Mounted on the vessel 18 also are desired pieces of equipment required for treating the cages. For example, a table 26 is provided for supporting a tumbler 28 that receives a cage and rotates it to tumble the contents and, among other things, dislodge unwanted debris and allow the contents of the cage to be sorted. If access to the interior of the cage is necessary, the removable portions 12 of the end caps can be unscrewed easily and then replaced. The cage is then returned to the body of water.

FIG. 5 shows the vessel 18 when the rope 20 is engaged by the guides 22 and 24 and a cage 2 is being lifted out of the water. In this embodiment, the guide 22 is located near the front of the vessel to allow the operator to detach the first end of the cage (i.e., the upper end in FIG. 5) from the rope, leaving the other end connected to the rope, and guide the first end of the cage onto the table 26 or the tumbler 28 (if installed on the table). Then, the operator detaches the other end of the cage from the rope and attends to treatment of the cage, as by tumbling, cleaning, etc., as described above. The operator then pulls the first end of the cage off the table (or the tumbler) and attaches that end to the rope, and finally attaches the second end to the rope so the cage can be put back in the water as the vessel moves along the rope. When the vessel comes to another cage, the process is repeated. Thus, in the embodiment shown the distance from the front of the table or the tumbler to the first guide 22 is preferably less than the length of a cage to facilitate placement of the cage on the table or tumbler.

The length of the tumbler is such that it can receive a cage in a position where the feet extend beyond both the front and rear sets of rollers to permit the cage to be rotated directly without removing the feet.

Alternate configurations are possible, for example, by providing a support structure between the first rope guide 22 and the table 26 or tumbler 28 to assist the operator in moving the cage onto the table or tumbler. Also, a chute (not shown) can be provided at the front of the vessel near the location where the cage 2 comes out of the water to support the cage as it is unclipped.

In performing the described method, the vessel can be moved along the rope by any of several means in addition to a motor provided on the vessel itself. A preferred means is to use a rope pulley 30 that can engage the rope and pull the boat along the rope at a desired speed, which can be slow enough to allow the operator adequate time to detach the cage from the rope. The pulley 30 is shown attached amidships to a gantry pole to be out of the way of the tumbler but can be mounted n other locations. When a cage is being treated or processed, it may be desirable to fix the position of the vessel with respect to the body of water, as by an anchor or a vertical stake that holds the vessel fixed with respect to the rope while the operator performs the operations on the cage and oysters.

It is within the scope of the invention to provide one or more of the elements shown in FIGS. 5 and 6, such as the table, the tumbler, the rope pulley, and the rope guides as a gunwale mounted system or self-contained module that can be attached to the gunwale of an existing boat. Thus, an existing waterman's boat, crab boat, dead rise boat, or similar commercial waterman's boat can be easily converted to a boat capable of practicing the described method.

In addition, such a module, or the components thereof, could be mounted on a tractor for use in the systems where the cages are attached to lines secured to the bottom of the body of water but accessible by a land vehicle. Such farms have lines tightly strung between pilings at intermittent distances from which the cages can be hung. The cages can be removed and tumbled or harvested at low tide. For example, some locations have large tidal variations that expose the ocean floor at low tide and allow harvesting from tractors or the like at low tide, and the process of the invention is applicable in that environment.

Modifications within the scope of the appended claims will be apparent to those of skill in the art.

I claim:

1. A cage comprising a permeable wall portion forming a cavity for receiving mollusks, and opposed end caps closing open ends of the wall portion, said end caps being secured to edges of said wall portion and at least one of the end caps being capable of being opened to provide access to said cavity.

2. A kit for forming a cage for holding mollusks comprising a mesh sheet and two end caps, wherein said mesh sheet has opposed edges each shaped to cooperate with a respective one of said end caps to secure said end cap to said edge.

3. A vessel for farming mollusks comprising a tumbler for receiving a cage containing said mollusks, a rope puller for pulling a rope attached to said cage onto said vessel, and rope guides for guiding said rope along said vessel as said vessel moves along said rope.

4. A method for farming mollusks comprising the use of the vessel of claim 3.
